(19) United States
(12) Patent Application Publication
(10) Pub. No.: US 2019/0213511 A1
(43) Pub. Date: Jul. 11, 2019

(54) PREDICTIVE SERVICE-REDUCTION REMEDIATION

(71) Applicant: International Business Machines Corporation, Armonk, NY (US)

(72) Inventors: ChunHui Y. Higgins, Durham, NC (US); William P. Higgins, Durham, NC (US); Bo Zhang, Cary, NC (US); Pu Yang, Cary, NC (US); Chul Sung, Austin, TX (US)

(21) Appl. No.: 15/865,325

(22) Filed: Jan. 9, 2018

(51) Int. Cl. G06Q 10/06; G06Q 30/02; G06F 17/30

(52) U.S. Cl. CPC G06Q 10/0635; G06Q 30/0204; G06F 17/30702; G06F 17/30867; G06Q 10/067

(57) ABSTRACT

A cognitive churn-analysis system of a customer-engagement management platform predicts when and why a customer is likely to reduce a current level of service of a current service offering. The system enhances results of a conventional statistical churn analysis by using cognitive methods to infer a customer's personality traits and evolving sentiment toward the service offering. By processing the results of the statistical analysis and the two cognitive analyses, the system predicts a likelihood that a customer will reduce service at a particular time by performing a churning activity. After further determining a likely reason why the customer would choose to churn, the cognitive system directs the customer-engagement management platform to educe the likelihood that the customer would make such a decision by engaging the customer with remedial actions at an optimal time.

### BACKGROUND

The present invention relates in general to improving current methods of performing a churn analysis and in particular to determining how to prevent high-risk customers from reducing their level of service.

A traditional churn analysis measures the rate of attrition in a company's customer base by identifying customers most likely to completely discontinue using a service or product. The results of such a churn analysis may be used by a customer relationship management (CRM) system or other type of customer-engagement management platform to develop and implement a strategy for customer retention.

Modern service-oriented cloud-computing platforms, however, must deal with other types of customer-engagement problems that, although analogous to traditional churning activities, are more nuanced. In the cloud, a customer may be offered multiple ways to purchase or subscribe to a cloud service that functions as a virtual application, infrastructure, or platform. In such cases, a cloud-services provider may be interested in knowing more detail about customer behavior than merely determining a rate at which customers cancel services.

Furthermore, current churn-analysis technology and customer-engagement management platforms are unable to predict when a customer is likely to churn, the reason for that the customer decides to perform a churning activity, a type of remedial action most likely to mitigate the chance that a customer will decide to churn, and an optimal time for a customer-engagement platform to perform such a remedial action.

### SUMMARY

An embodiment of the present invention is a cognitive churn-analysis system of a customer-engagement management platform comprising a processor, a memory coupled to the processor, and a computer-readable hardware storage device coupled to the processor, the storage device containing program code configured to be run by the processor via the memory to implement a method for predictive service-reduction remediation, the method comprising:

the system receiving system data that characterizes a set of customers during a first time period and associates each customer of the set of customers with at least one service of a set of candidate service offerings;

the system receiving cognitive customer data associated with online activities of the set of customers during a second time period;

the system performing a statistical analysis on the system data to identify likelihoods that high-risk customers of the set of customers will engage in churning activities;

the system performing a cognitive personality analysis on the cognitive customer data to produce a personality profile for each high-risk customer that represents the high-risk customer's personality as a weighted set of personality traits;

the system performing a cognitive sentiment analysis on the cognitive customer data to produce a time-ordered sequence of sentiment profiles for each high-risk customer, where each produced sentiment profile comprises a weighted set of sentiments from which the system infers a sentiment expressed by an element of the cognitive customer data;

the system performing a cognitive churn analysis upon outputs of the statistical analysis, the cognitive personality analysis, and the cognitive sentiment analysis, where the cognitive churn analysis infers:

reasons why each high-risk customer is likely to engage in a churning activity,

churn times at which each high-risk customer is likely to engage in a churning activity,

remedial actions each capable of reducing a likelihood that a high-risk customer will engage in a churning activity, and

optimal times at which to perform each remedial action; and

the system directing the customer-engagement management platform to schedule and perform the remedial actions at the optimal times.

Another embodiment of the present invention is a method for predictive service-reduction remediation, the method comprising:

a cognitive churn-analysis system of a customer-engagement management platform receiving system data that characterizes a set of customers during a first time period and associates each customer of the set of customers with at least one service of a set of candidate service offerings;

the system receiving cognitive customer data associated with online activities of the set of customers during a second time period;

the system performing a statistical analysis on the system data to identify likelihood that high-risk customers of the set of customers will engage in churning activities;

the system performing a cognitive personality analysis on the cognitive customer data to produce a personality profile for each high-risk customer that represents the high-risk customer's personality as a weighted set of personality traits;

the system performing a cognitive sentiment analysis on the cognitive customer data to produce a time-ordered sequence of sentiment profiles for each high-risk customer, where each produced sentiment profile comprises a weighted set of sentiments from which the system infers a sentiment expressed by an element of the cognitive customer data;

the system performing a cognitive churn analysis upon outputs of the statistical analysis, the cognitive personality analysis, and the cognitive sentiment analysis, where the cognitive churn analysis infers:

reasons why each high-risk customer is likely to engage in a churning activity,

churn times at which each high-risk customer is likely to engage in a churning activity,

remedial actions each capable of reducing a likelihood that a high-risk customer will engage in a churning activity, and

optimal times at which to perform each remedial action; and

the system directing the customer-engagement management platform to schedule and perform the remedial actions at the optimal times.

Yet another embodiment of the present invention is a computer program product, comprising a computer-readable hardware storage device having a computer-readable program code stored therein, the program code configured to be executed by cognitive churn-analysis system of a customer-engagement management platform comprising a processor, a memory coupled to the processor, and a computer-readable hardware storage device coupled to the processor, the storage device containing program code configured to be run by the processor via the memory to implement a method for predictive service-reduction remediation, the method comprising:

the system receiving system data that characterizes a set of customers during a first time period and associates each customer of the set of customers with at least one service of a set of candidate service offerings;

the system receiving cognitive customer data associated with online activities of the set of customers during a second time period;

the system performing a statistical analysis on the system data to identify likelihoods that high-risk customers of the set of customers will engage in churning activities;

the system performing a cognitive personality analysis on the cognitive customer data to produce a personality profile for each high-risk customer that represents the high-risk customer's personality as a weighted set of personality traits;

the system performing a cognitive sentiment analysis on the cognitive customer data to produce a time-ordered sequence of sentiment profiles for each high-risk customer, where each produced sentiment profile comprises a weighted set of sentiments from which the system infers a sentiment expressed by an element of the cognitive customer data;

the system performing a cognitive churn analysis upon outputs of the statistical analysis, the cognitive personality analysis, and the cognitive sentiment analysis, where the cognitive churn analysis infers:

reasons why each high-risk customer is likely to engage in a churning activity,

churn times at which each high-risk customer is likely to engage in a churning activity,

remedial actions each capable of reducing a likelihood that a high-risk customer will engage in a churning activity, and

optimal times at which to perform each remedial action; and

the system directing the customer-engagement management platform to schedule and perform the remedial actions at the optimal times.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 shows the structure of a computer system and computer program code that may be used to implement a method for predictive service-reduction remediation in accordance with embodiments of the present invention.

FIG. 4 is a flow chart that illustrates steps of a method for predictive service-reduction remediation in accordance with embodiments of the present invention.

### DETAILED DESCRIPTION

A traditional churn analysis measures the rate of attrition in a company's customer base by identifying customers most likely to discontinue using a service or product. The results of a churn analysis may be used by a customer relationship management (CRM) system or other type of customer-engagement management platform to develop and implement a strategy for customer retention.

Modern service-oriented cloud-computing platforms must deal with more general problems that may be analogous to traditional churning issues. In the cloud, a customer may subscribe to a cloud service that functions as an application, infrastructure, or platform provisioned to the customer's specific needs. In such cases, a cloud-services provider may be interested in knowing more detail about customer behavior than merely determining a rate at which customers cancel service.

This is especially true because cloud providers may offer a variety of billing models. For such providers, a more useful, enhanced definition of churning may include:
free-trial customers that drop a service after a trial period ends without converting to a pay model;
per-usage billing customers that significantly lower their payments by reducing usage of a service;
per-service flat-rate subscribers that lower payments by reconfiguring their subscriptions to include fewer or less-expensive services; and
pay-as-you-go customers that simply cancel an account.

A traditional churn analysis based on relatively simple statistical or data-science computations generally tracks or measures only cancellation-related behavior. Furthermore, such methods cannot provide critical business information regarding when a particular customer is likely to churn, why that customer may churn at that time, the type of remedial action most likely to mitigate the chance of churning, and an optimal time to undertake the remedial action.

Embodiments of the present invention address these issues by using cognitive-data analysis tools to improve known churn-analysis functionality of a customer-engagement management platform. In this document, a customer-engagement management platform is defined as any automated, computerized, or software-driven system that connects customers with agents or customer-management centers and manages characteristics of communications between customers and agents or customer-management centers. These automated systems ensure that a customer is connected to the right agent at the right time to make a sale or solve an issue, and that the agent performs the correct actions needed to achieve those goals at that time.

The present invention uses known cognitive-data analysis tools to generate cognitive inputs to an enhanced churn-analysis system of a customer-engagement management platform. This system identifies customers or other types of users that are at high risk of churning, and then predicts the most likely time at which each such customer may churn and the reason why each such customer might churn. The system then uses other cognitive tools to identify remedial actions most likely to mitigate each customer's potential churning, and an optimal time to undertake such remedial action. This information is then returned to the churn-analysis system's parent customer-engagement management platform, which ensures that a correct agent contacts each customer at an optimal time to perform the remedial actions identified as being most likely to prevent that customer from churning.

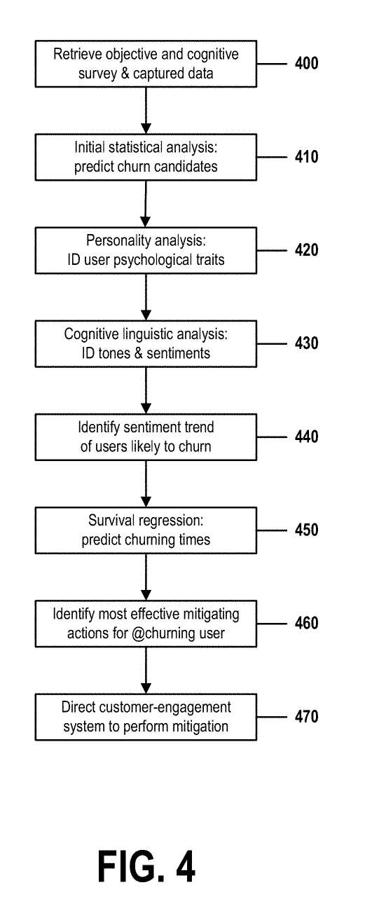

As explained in FIG. 4, the present invention implements this improvement by means of novel application of known tools of cognitive data analysis, online analytics, statistics, or artificial intelligence, such as cognitive personality analysis, linguistic analysis, sentiment analysis, neural networks, convolutional neural networks, and survival-regression analysis.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

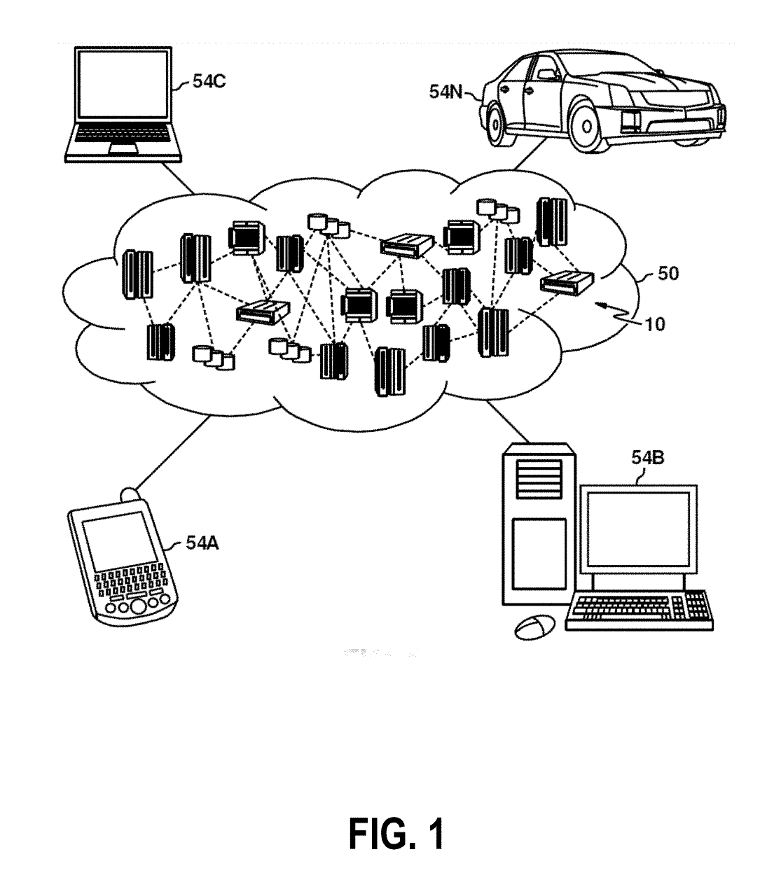

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

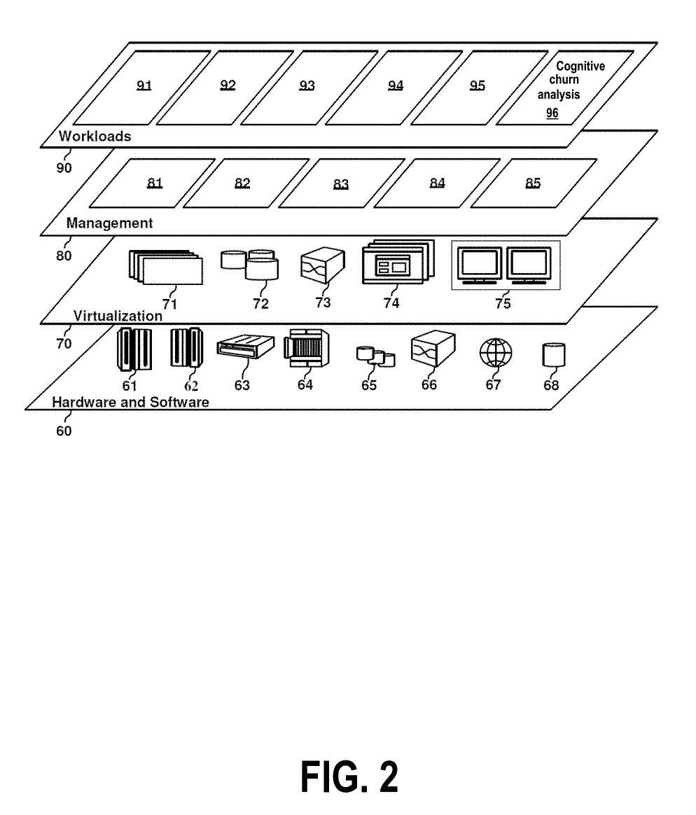

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and orchestration of cognitive churn analyses 96.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer nay be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

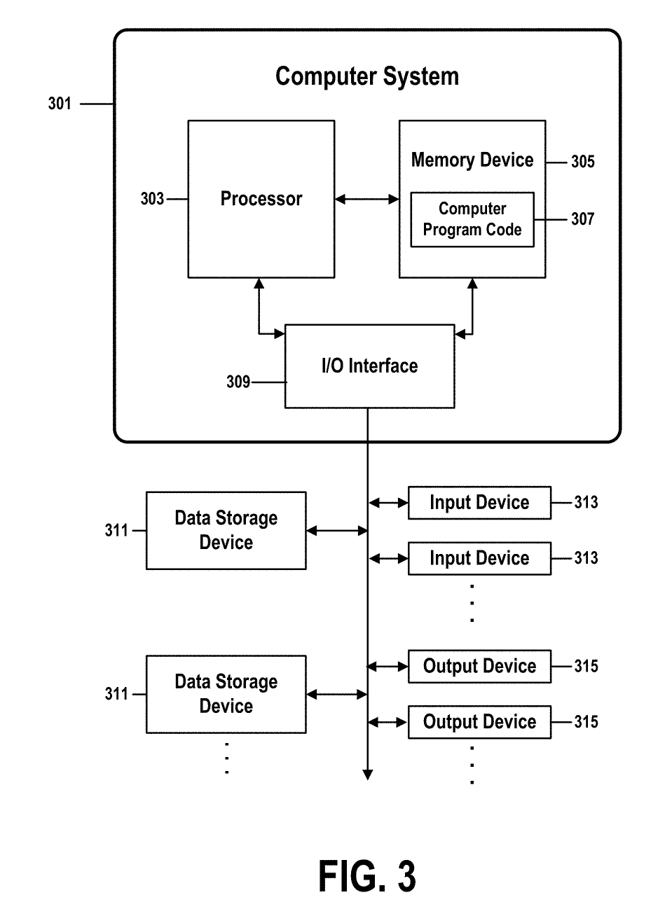

FIG. 3 shows a structure of a computer system and computer program code that may be used to implement a method for predictive service-reduction remediation in accordance with embodiments of the present invention. FIG. 3 refers to objects 301-315.

In FIG. 3, computer system 301 comprises a processor 303 coupled through one or more I/O Interfaces 309 to one or more hardware data storage devices 311 and one or more I/O devices 313 and 315.

Hardware data storage devices 311 may include, but are not limited to, magnetic tape drives, fixed or removable hard disks, optical discs, storage-equipped mobile devices, and solid-state random-access or read-only storage devices. I/O devices may comprise, but are not limited to: input devices 313, such as keyboards, scanners, handheld telecommunications devices, touch-sensitive displays, tablets, biometric readers, joysticks, trackballs, or computer mice; and output devices 315, which may comprise, but are not limited to printers, plotters, tablets, mobile telephones, displays, or sound-producing devices. Data storage devices 311, input devices 313, and output devices 315 may be located either locally or at remote sites from which they are connected to I/O Interface 309 through a network interface.

Processor 303 may also be connected to one or more memory devices 305, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 305 contains stored computer program code 307, which is a computer program that comprises computer-executable instructions. The stored computer program code includes a program that implements a method for predictive service-reduction remediation in accordance with embodiments of the present invention, and may implement other embodiments described in this specification, including the methods illustrated in FIGS. 1-4. The data storage devices 311 may store the computer program code 307. Computer program code 307 stored in the storage devices 311 is configured to be executed by processor 303 via the memory devices 305. Processor 303 executes the stored computer program code 307.

In some embodiments, rather than being stored and accessed from a hard drive, optical disc or other writeable, rewriteable, or removable hardware data-storage device 311, stored computer program code 307 may be stored on a static, nonremovable, read-only storage medium such as a Read-Only Memory (ROM) device 305, or may be accessed by processor 303 directly from such a static, nonremovable, read-only medium 305. Similarly, in some embodiments, stored computer program code 307 may be stored as computer-readable firmware 305, or may be accessed by processor 303 directly from such firmware 305, rather than from a more dynamic or removable hardware data-storage device 311, such as a hard drive or optical disc.

Thus the present invention discloses a process for supporting computer infrastructure, integrating, hosting, maintaining, and deploying computer-readable code into the computer system 301, wherein the code in combination with the computer system 301 is capable of performing a method for predictive service-reduction remediation.

Any of the components of the present invention could be created, integrated, hosted, maintained, deployed, managed, serviced, supported, etc. by a service provider who offers to facilitate a method for predictive service-reduction remediation. Thus the present invention discloses a process for deploying or integrating computing infrastructure, comprising integrating computer-readable code into the computer system 301, wherein the code in combination with the computer system 301 is capable of performing a method for predictive service-reduction remediation.

One or more data storage units 311 (or one or more additional memory devices not shown in FIG. 3) may be used as a computer-readable hardware storage device having a computer-readable program embodied therein and/or having other data stored therein, wherein the computer-readable program comprises stored computer program code 307. Generally, a computer program product (or, alternatively, an article of manufacture) of computer system 301 may comprise the computer-readable hardware storage device.

In embodiments that comprise components of a networked computing infrastructure, a cloud-computing environment, a client-server architecture, or other types of distributed platforms, functionality of the present invention may be implemented solely on a client or user device, may be implemented solely on a remote server or as a service of a cloud-computing platform, or may be split between local and remote components.

While it is understood that program code 307 for a method for predictive service-reduction remediation may be deployed by manually loading the program code 307 directly into client, server, and proxy computers (not shown) by loading the program code 307 into a computer-readable storage medium (e.g., computer data storage device 311), program code 307 may also be automatically or semi-automatically deployed into computer system 301 by sending program code 307 to a central server (e.g., computer system 301) or to a group of central servers. Program code 307 may then be downloaded into client computers (not shown) that will execute program code 307.

Alternatively, program code 307 may be sent directly to the client computer via e-mail. Program code 307 may then either be detached to a directory on the client computer or loaded into a directory on the client computer by an e-mail option that selects a program that detaches program code 307 into the directory.

Another alternative is to send program code 307 directly to a directory on the client computer hard drive. If proxy servers are configured, the process selects the proxy server code, determines on which computers to place the proxy servers' code, transmits the proxy server code, and then installs the proxy server code on the proxy computer. Program code 307 is then transmitted to the proxy server and stored on the proxy server.

In one embodiment, program code 307 for a method for predictive service-reduction remediation is integrated into a client, server and network environment by providing for program code 307 to coexist with software applications (not shown), operating systems (not shown) and network operating systems software (not shown) and then installing program code 307 on the clients and servers in the environment where program code 307 will function.

The first step of the aforementioned integration of code included in program code 307 is to identify any software on the clients and servers, including the network operating system (not shown), where program code 307 will be deployed that are required by program code 307 or that work in conjunction with program code 307. This identified software includes the network operating system, where the network operating system comprises software that enhances a basic operating system by adding networking features. Next, the software applications and version numbers are identified and compared to a list of software applications and correct version numbers that have been tested to work with program code 307. A software application that is missing or that does not match a correct version number is upgraded to the correct version.

A program instruction that passes parameters from program code 307 to a software application is checked to ensure that the instruction's parameter list matches a parameter list required by the program code 307. Conversely, a parameter passed by the software application to program code 307 is checked to ensure that the parameter matches a parameter required by program code 307. The client and server operating systems, including the network operating systems, are identified and compared to a list of operating systems, version numbers, and network software programs that have been tested to work with program code 307. An operating system, version number, or network software program that does not match an entry of the list of tested operating systems and version numbers is upgraded to the listed level on the client computers and upgraded to the listed level on the server computers.

After ensuring that the software, where program code 307 is to be deployed, is at a correct version level that has been tested to work with program code 307, the integration is completed by installing program code 307 on the clients and servers.

Embodiments of the present invention may be implemented as a method performed by a processor of a computer system, as a computer program product, as a computer system, or as a processor-performed process or service for supporting computer infrastructure.

FIG. 4 is a flow chart that illustrates the steps of a method for predictive service-reduction remediation in accordance with embodiments of the present invention. FIG. 4 contains steps 400-470.

In FIG. 4, a churn-analysis system of a customer-engagement management platform performs a cognitive churn analysis by using cognitive data-analysis technologies to develop cognitive inputs to an enhanced churn-analysis computation. The results of this cognitive churn analysis are returned to the customer-engagement management platform, directing the platform to perform specific remedial customer-engagement activities at those times most likely to reduce the possibility that high-risk customers will undertake churning behavior.

This procedure begins with step 400, in which the churn-analysis system receives sets of cognitive and objective data upon which analyses of steps 410-450 may be performed. This data may characterize each customer being considered and may also be related to an application, platform, service, or contractual agreement associated with the customer's usage of a relevant service.

This data may be received through any means known in the art, such as by querying databases, retrieving log files associated with application instances, receiving pushed data from a cloud-management platform, consulting a cloud service directory, or accessing stored customer profiles, transaction logs, natural-language input to an application's user interface, survey results, social-network postings, email threads, network-traffic statistics, or user-account information. Embodiments of the present invention are flexible enough to accommodate any sort of input that an implementer deems to be capable of allowing the cognitive churn analysis to produce more relevant or accurate results.

Examples of the types of data that may be received in step 400 will be enumerated in the following descriptions of subsequent steps of FIG. 4.

In step 410, the system performs a conventional churn analysis in order to identify likelihoods that candidate customers will churn within a specified duration of time known as a “lifetime.” In embodiments of the present invention, however, the candidates processed in step 410 will be further evaluated by cognitive analyses of subsequent steps in order to determine whether their churning behavior comprises terminating a service, reducing usage of a service, reconfiguring a service to remove a component, terminating a free trial without purchasing a paid service, or another type of service reduction that may be deemed relevant by an implementer.

This known method churn analysis may use data-analysis or statistical techniques to process data received in step 400. That processed data may include information like each customer's current or past service-usage, network-traffic, or resource-consumption statistics, or logged system-event data (such as a frequency of system crashes or application updates).

At the conclusion of step 410, the system will have produced a set of probabilities that each identify a relative probability that a corresponding customer may exhibit churning behavior within the specified “lifetime” period of time. As will be discussed below, this set of probabilities will become a first set of inputs for the cognitive churn-analysis performed in step 450.

In step 420, the system identifies personality traits of each customer by means of a cognitive personality analysis. This step is performed by applying known techniques of artificially intelligent personality-analysis to data received in step 400. One example of a commercially available application capable of performing such a personality analysis is IBM's Watson Personality Insights service.

The system in this step uses the personality analysis to derive insights from transactional and social-media data received in step 400, such as tweets, postings, product reviews, and online comments. In some embodiments, this received data may include content that is not publicly available, such as intra-office electronic communications or text messages. If the received data is received as natural language, the system may incorporate an NLP (natural-language processing) front end in order to infer meaning from the natural-language input.

The insights inferred from the received data in this step allow the system to identify psychological traits of each customer that may affect that customer's churn decisions. At the conclusion of step 420, the system will have developed for each customer a personality profile that may take any form known in the art.

In one example, a customer's personality profile may comprise a list of personality traits, such as “curiosity,” “introversion,” “stability,” “excitement,” and “self-expression,” and a corresponding value associated with each trait that identifies the relative prominence of that trait in the customer's personality.

The personality profiles derived in this step will be used as a second set of cognitive inputs for the cognitive churn-analysis performed in step 450.

In step 430, the system performs a sentiment analysis for each customer by means of a cognitive linguistic analysis. This step is performed by applying known techniques of artificially intelligent linguistic analysis to data received in step 400 in order to infer meaning from the data as a function of word sequencing, phonology (speech sound patterns), syntax, semantics, morphology, and other linguistic attributes of the data. One example of a commercially available application capable of performing such linguistic analyses is IBM's Watson Personality Insights service.

The system in this step performs cognitive linguistic analyses upon the elements of customer-generated transactional and social-media data similar to the data processed in step 420. As in step 420, if the processed data is expressed as natural language, the system may in step 430 incorporate an NLP (natural-language processing) front end in order to infer meaning from the natural-language input.

The insights inferred from the received data in this step allow the system to infer a customer's tone or sentiment from each element of content generated by that customer. At the conclusion of step 430, the system will have developed for each customer a set of sentiment profiles that may each take any form known in the art.

In one example, a customer's sentiment profile may comprise a list of sentiments inferred from one or more online postings, such as “anger,” “joy,” “fear,” or “sadness,” or may simply categorize the customer sentiment as “positive,” “negative,” or “neutral.” The system in this step will associate a numeric value with each sentiment in the profile, where that value identifies a relative level of that sentiment expressed in the particular element of received content being analyzed.

In some embodiments, the system may derive multiple sentiment profiles for each customer, where each sentiment profile characterizes that customer's sentiment at a particular time or during a particular range of time. As will be discussed in step 440, such a sequence of sentiment profiles will allow the cognitive churn-analysis system to identify time-varying trends in a customer's sentiment.

In step 440, the system organizes the sentiment profiles derived in step 430 in order to identify time-varying trends in each user's sentiment throughout the “lifetime” duration of time identified in step 410.

In one example, consider a case where the system in step 430 generated four weekly sentiment profiles for a certain customer based on that customer's postings during a “lifetime” period spanning the current-year month of December. In this simple example, each sentiment profile identifies only two sentiments, “anger,” and “joy.” During that month, the four profiles, organized chronologically, comprised “anger” values of 35%, 32%, 42%, and 3%; and “joy” values of 15%, 18%, 19%, and 71%. The system, by means of a linear regression analysis or other known mathematical method, might infer two sentiment trends: a slight increase in anger and decrease in joyfulness during the first three weeks of the month, and a dramatic decrease in anger and increase in joy during the final week of the month.

The sentiment trends derived in this step will become a third set of cognitive inputs for the cognitive churn-analysis performed in step 450.

In step 450, the system performs a cognitive churn analysis directed to predicting when each identified churning-behavior event is likely to occur during the specified lifetime period of time. This cognitive churn analysis may be performed by any statistical, cognitive, or mathematical techniques known in the art, such as by means of a survival-regression analysis (or reliability analysis), upon the three sets of inputs generated in steps 410, 420, and 430.

Survival regression, as in known in the field of reliability theory, is capable of predicting when a certain event will occur during a specified “lifetime” period of time. Such an analysis may be performed by generating a predictive model known in the field as “Cox's model” or by generating an alternate predictive model known as “Aalen's Additive model.”

Some embodiments of the present invention may thus perform step 450 by applying a survival regression analysis to the novel combination of churn-analysis inputs generated in steps 410, 420, and 430 in order to determine the times when each customer is most likely to perform a churning action.

In step 460, the cognitive churn-analysis system identifies mitigating actions that should be performed by the customer-engagement management system in order to most effectively remediate a customer's predicted service-reduction or other churning activity.

This identification may be made as a function of the output of steps 410, 420, 440, and 450. For example, the system may initially select a set of customers identified by step 410 as being most likely to churn during the lifetime period. The system may then, using the output of step 450, organizing the selected customers chronologically as a function of the time each customer is expected to churn.

Finally, the system may use the personality profiles and sentiment trends generated in steps 420 and 440 to select remedial actions most likely to be effective for each selected customer. For example, if a customer's personality profile reveals a strong tendency to worry about financial matters and the customer's sentiment trend indicates that the customer's overall anxiety level has increased steadily during the preceding month, as a holiday season approaches, the system may, by means of cognitive analytics, determine that the customer's impending churn decision may be motivated by cost. In response, the system might then select a three-month discount as a preferred remedial action and further specify that the remedial action be undertaken by an agent with the authority to negotiate such a discount.

In another example, if a customer's personality profile portrays the customer as being perennially detail-oriented and meticulous, and if the customer's sentiment trend shows increasing levels of impatience and frustration, the system may infer that a likely reason for the customer's predicted decision to cancel a subscribed service is because the customer cannot find sufficient time to use the service. In this case, the system may determine that a most effective remedial action would be to allow the customer to transition from flat-rate billing to a per-hour usage-based payment method. If the subscribed service is subject to complex billing terms, the system may further specify that the remedial action be undertaken by an agent who has had sufficient training in the relevant billing methods.

In these examples, the system would also use an analogous cognitive approach to determine an optimal time to perform the remedial action. For example, if the system determines in step 450 that a customer is most likely to churn during the last few days before the customer's current subscription ends, and if the customer's personality profile indicates that the customer is highly impulsive, the system might in this step infer that the customer has a tendency toward impulse purchases and recommend that a remedial action be performed a week before the end of the subscription term.

On the other hand, if the customer's personality profile suggests that the customer is methodical and not prone to snap decisions, the system might recommend that an agent contact the customer several times during the month before the subscription ends, in order to give the customer time to fully consider and become comfortable with a remedial offer.

In a real-world implementation, these inferences may be far more complex and nuanced, but given the cognitive and statistically derived data sets generated in steps 410, 420, 440, and 450, such inferences are well within the capability of numerous known methods of online analytics, cognitive inference engines, and artificially intelligent applications.

In step 470, the cognitive churn-analysis system returns to its parent customer-engagement management platform:

i) a list of customers most likely to perform a churning activity during the selected lifetime period under consideration;

ii) a likely reason for each listed customer's predicted churning activity;

iii) a time when each listed customer is most likely to churn;

iv) a remedial action most likely to avoid or mitigate the predicted churning activity; and

v) an optimal time to perform the remedial action.

The customer-engagement management platform responds by integrating the churn-analysis system's recommendations into the platform's engagement plans for the listed customers. The platform then schedules and directs appropriate agents to engage the listed customers in the recommended remedial actions at the optimal times.

Examples and embodiments of the present invention described in this document have been presented for illustrative purposes. They should not be construed to be exhaustive nor to limit embodiments of the present invention to the examples and embodiments described here. Many other modifications and variations of the present invention that do not depart from the scope and spirit of these examples and embodiments will be apparent to those possessed of ordinary skill in the art. The terminology used in this document was chosen to best explain the principles underlying these examples and embodiments, in order to illustrate practical applications and technical improvements of the present invention over known technologies and products, and to enable readers of ordinary skill in the art to better understand the examples and embodiments disclosed here.

For example, embodiments of the present invention may perform the steps of FIG. 4 in a different order, or may perform certain steps, such as the personality analysis and the sentiment analysis, concurrently. In another example, the statistical, personality, and sentiment analyses may be performed over different time periods. Similarly, the data received in step 400 may comprise individual items that collected at different times or that reference information associated with different time periods.

In all cases, however, the general inventive concept of a churn analysis system that operates upon data inferred by cognitive analysis should be maintained. Likewise the underlying logical flow of the invention should be maintained, such that the three initial analyses (the statistical analysis of step 410, the personality analysis of step 420, and the sentiment analysis of steps 430 and 440) each produce output that becomes one of three inputs to the final cognitive churn analysis of steps 450 and 460; and that the output of the cognitive churn analysis is used to direct the engagement management platform to schedule and perform the recommended remedial actions at the specified times.

What is claimed is:

1. A cognitive churn-analysis system of a customer-engagement management platform comprising a processor, a memory coupled to the processor, and a computer-readable hardware storage device coupled to the processor, the storage device containing program code configured to be run by the processor via the memory to implement a method for predictive service-reduction remediation, the method comprising:
the system receiving system data that characterizes a set of customers during a first time period and associates each customer of the set of customers with at least one service of a set of candidate service offerings;
the system receiving cognitive customer data associated with online activities of the set of customers during a second time period;
the system performing a statistical analysis on the system data to identify likelihoods that high-risk customers of the set of customers will engage in churning activities;
the system performing a cognitive personality analysis on the cognitive customer data to produce a personality profile for each high-risk customer that represents the high-risk customer's personality as a weighted set of personality traits;
the system performing a cognitive sentiment analysis on the cognitive customer data to produce a time-ordered sequence of sentiment profiles for each high-risk customer, where each produced sentiment profile comprises a weighted set of sentiments from which the system infers a sentiment expressed by an element of the cognitive customer data;
the system performing a cognitive churn analysis upon outputs of the statistical analysis, the cognitive personality analysis, and the cognitive sentiment analysis, where the cognitive churn analysis infers:
reasons why each high-risk customer is likely to engage in a churning activity,
churn times at which each high-risk customer is likely to engage in a churning activity,
remedial actions each capable of reducing a likelihood that a high-risk customer will engage in a churning activity, and
optimal times at which to perform each remedial action; and
the system directing the customer-engagement management platform to schedule and perform the remedial actions at the optimal times.

2. The system of claim 1, where the cognitive sentiment analysis further comprises:
the system inferring a sentiment trend for a first high-risk customer as a function of the first high-risk customer's time-ordered sequence of sentiment profiles,
where the sentiment trend is capable of predicting a future sentiment of the first high-risk customer, and
where the future sentiment is capable of influencing the first high-risk customer's decision to engage in a churning activity.

3. The system of claim 1, where the sentiment analysis comprises a linguistic analysis performed upon a natural-language statement, comprised by the cognitive customer data, made by high-risk customer.

4. The system of claim 1, where the cognitive churn analysis comprises a survival-regression analysis that identifies the churn times.

5. The system of claim 1, where the cognitive churn analysis further comprises:
the system inferring the optimal times as a function of the churn times.

6. The system of claim 1, where a churning activity consists of a customer canceling a billable service.

7. The system of claim 1, where a first churning activity consists of a customer performing an action selected from the group consisting of:
canceling a billable pay-as-you-go service,
canceling a billable subscription service,
terminating a free service without replacing the free with a billable service,
reducing usage of a service that is billed as a function of usage, and
reconfiguring modules of a modular service so as to reduce a cost of the modular service.

8. A method for predictive service-reduction remediation, the method comprising:
a cognitive churn-analysis system of a customer-engagement management platform receiving system data that characterizes a set of customers during a first time period and associates each customer of the set of customers with at least one service of a set of candidate service offerings;
the system receiving cognitive customer data associated with online activities of the set of customers during a second time period;
the system performing a statistical analysis on the system data to identify likelihoods that high-risk customers of the set of customers will engage in churning activities;
the system performing a cognitive personality analysis on the cognitive customer data to produce a personality profile for each high-risk customer that represents the high-risk customer's personality as a weighted set of personality traits;
the system performing a cognitive sentiment analysis on the cognitive customer data to produce a time-ordered sequence of sentiment profiles for each high-risk customer, where each produced sentiment profile comprises a weighted set of sentiments from which the system infers a sentiment expressed by an element of the cognitive customer data;
the system performing a cognitive churn analysis upon outputs of the statistical analysis, the cognitive personality analysis, and the cognitive sentiment analysis, where the cognitive churn analysis infers:
reasons why each high-risk customer is likely to engage in a churning activity,
churn times at which each high-risk customer is likely to engage in a churning activity,
remedial actions each capable of reducing a likelihood that a high-risk customer will engage in a churning activity, and
optimal times at which to perform each remedial action; and
the system directing the customer-engagement management platform to schedule and perform the remedial actions at the optimal times.

9. The method of claim 8, where the cognitive sentiment analysis further comprises:
the system inferring a sentiment trend for a first high-risk customer as a function of the first high-risk customer's time-ordered sequence of sentiment profiles,
where the sentiment trend is capable of predicting a future sentiment of the first high-risk customer, and
where the future sentiment is capable of influencing the first high-risk customer's decision to engage in a churning activity.

10. The method of claim 8, where the sentiment analysis comprises a linguistic analysis performed upon a natural-language statement, comprised by the cognitive customer data, made by high-risk customer.

11. The method of claim 8, where the cognitive churn analysis comprises a survival-regression analysis that identifies the churn times.

12. The method of claim 8, where the cognitive churn analysis further comprises:
the system inferring the optimal times as a function of the churn times.

13. The method of claim 8, where a first churning activity consists of a customer performing an action selected from the group consisting of:
canceling a billable pay-as-you-go service,
canceling a billable subscription service,
terminating a free service without replacing the free with a billable service,
reducing usage of a service that is billed as a function of usage, and
reconfiguring modules of a modular service so as to reduce a cost of the modular service.

14. The method of claim 8, further comprising providing at least one support service for at least one of creating, integrating, hosting, maintaining, and deploying computer-readable program code in the computer system, wherein the computer-readable program code in combination with the computer system is configured to implement the receiving system data, the receiving cognitive customer data, the performing a statistical analysis, the performing a cognitive personality analysis, the performing a cognitive sentiment analysis, the performing a cognitive churn analysis, and the directing the customer-engagement management platform.

15. A computer program product, comprising a computer-readable hardware storage device having a computer-readable program code stored therein, the program code configured to be executed by cognitive churn-analysis system of a customer-engagement management platform comprising a processor, a memory coupled to the processor, and a computer-readable hardware storage device coupled to the processor, the storage device containing program code configured to be run by the processor via the memory to implement a method for predictive service-reduction remediation, the method comprising:
the system receiving system data that characterizes a set of customers during a first time period and associates each customer of the set of customers with at least one service of a set of candidate service offerings;
the system receiving cognitive customer data associated with online activities of the set of customers during a second time period;
the system performing a statistical analysis on the system data to identify likelihoods that high-risk customers of the set of customers will engage in churning activities;
the system performing a cognitive personality analysis on the cognitive customer data to produce a personality profile for each high-risk customer that represents the high-risk customer's personality as a weighted set of personality traits;
the system performing a cognitive sentiment analysis on the cognitive customer data to produce a time-ordered sequence of sentiment profiles for each high-risk customer, where each produced sentiment profile comprises a weighted set of sentiments from which the system infers a sentiment expressed by an element of the cognitive customer data;
the system performing a cognitive churn analysis upon outputs of the statistical analysis, the cognitive personality analysis, and the cognitive sentiment analysis, where the cognitive churn analysis infers:
reasons why each high-risk customer is likely to engage in a churning activity,
churn times at which each high-risk customer is likely to engage in a churning activity,
remedial actions each capable of reducing a likelihood that a high-risk customer will engage in a churning activity, and
optimal times at which to perform each remedial action; and
the system directing the customer-engagement management platform to schedule and perform the remedial actions at the optimal times.

16. The computer program product of claim 15, where the cognitive sentiment analysis further comprises:
the system inferring a sentiment trend for a first high-risk customer as a function of the first high-risk customer's time-ordered sequence of sentiment profiles,
where the sentiment trend is capable of predicting a future sentiment of the first high-risk customer, and
where the future sentiment is capable of influencing the first high-risk customer's decision to engage in a churning activity.

17. The computer program product of claim 15, where the sentiment analysis comprises a linguistic analysis performed upon a natural-language statement, comprised by the cognitive customer data, made by high-risk customer.

18. The computer program product of claim 15, where the cognitive churn analysis comprises a survival-regression analysis that identifies the churn times.

19. The computer program product of claim 15, where the cognitive churn analysis further comprises:
the system inferring the optimal times as a function of the churn times.

20. The computer program product of claim 15, where a first churning activity consists of a customer performing an action selected from the group consisting of:
canceling a billable pay-as-you-go service,
canceling a billable subscription service,
terminating a free service without replacing the free with a billable service,
reducing usage of a service that is billed as a function of usage, and
reconfiguring modules of a modular service so as to reduce a cost of the modular service.
